(19) United States
(12) Patent Application Publication
(10) Pub. No.: US 2025/0165262 A1
(43) Pub. Date: May 22, 2025

(54) CONFIGURATION DATA ANALYZER

(71) Applicant: ServiceNow, Inc., Santa Clara, CA (US)

(72) Inventors: Ravindra Bansal, Belmont, CA (US); Swapnesh Patel, Bothell, WA (US); Hyung Jun Kim, Edmonds, WA (US); Anand Karandikar, Bothell, WA (US)

(21) Appl. No.: 18/512,807

(22) Filed: Nov. 17, 2023

(51) Int. Cl. G06F 9/445

(52) U.S. Cl. CPC G06F 9/4451

(57) ABSTRACT

In various embodiments, a process for providing a configuration data analyzer includes ingesting a first configuration of a first deployment of an application service and ingesting a second configuration of a second deployment of the application service. The process includes comparing organizational structures and elements of the first configuration against the second configuration. The process includes providing, via a user interface, an interactive view indicating differences between the organizational structures and the elements of the first configuration and the second configuration for the first and second different deployments of the application service.

### BACKGROUND OF THE INVENTION

A computer application or infrastructure typically has various configuration data or settings (e.g., key-value pairs) that define how the computer application functions. The configuration data may change during the course of development or evolution of the computer application. Such changes may cause the computer application to perform better or more poorly. Being able to attribute performance changes to configuration data properties and changes may be helpful for improving the functioning of the computer applications. However, conventional tools for analyzing configuration data are typically unable to compare and contrast configuration data for two or more different computer applications, especially when the volume of data is on the order of thousands or millions of key-value pairs. Thus, there is a need for an improved configuration data analyzer.

### BRIEF DESCRIPTION OF THE DRAWINGS

Various embodiments of the invention are disclosed in the following detailed description and the accompanying drawings.

FIG. 1 is a flow diagram illustrating an embodiment of a process for providing a configuration data analyzer.

FIG. 2 is a flow diagram illustrating an embodiment of a process for building a data model based on a configuration file.

FIG. 3A shows examples of configuration data, how the configuration data is stored, and where the configuration data can be stored.

FIG. 3B shows an example of configuration data. In this example, the configuration data is shown as a JSON file.

FIG. 3C shows an example of configuration data arranged in a data model view.

FIG. 4 is a conceptual diagram illustrating an embodiment of analysis of two sets of configuration data.

FIG. 5 is a block diagram illustrating an embodiment of a network environment including a configuration data analyzer.

FIG. 6 is a block diagram illustrating an embodiment of a configuration data analyzer.

FIG. 7 shows an example of a graphical user interface for providing an overview of configuration data.

FIG. 8 shows an example of a graphical user interface for a snapshot.

FIG. 9 shows an example of a graphical user interface for comparing configuration data.

FIG. 10 shows an example of a graphical user interface for comparing data models.

FIG. 11 shows an example of a graphical user interface for comparing applications.

FIG. 12 shows an example of a graphical user interface for displaying differences in configuration data.

FIG. 13 shows another example of a graphical user interface for displaying differences in configuration data.

FIG. 14 is a functional diagram illustrating a programmed computer system for providing a configuration data analyzer in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications, and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

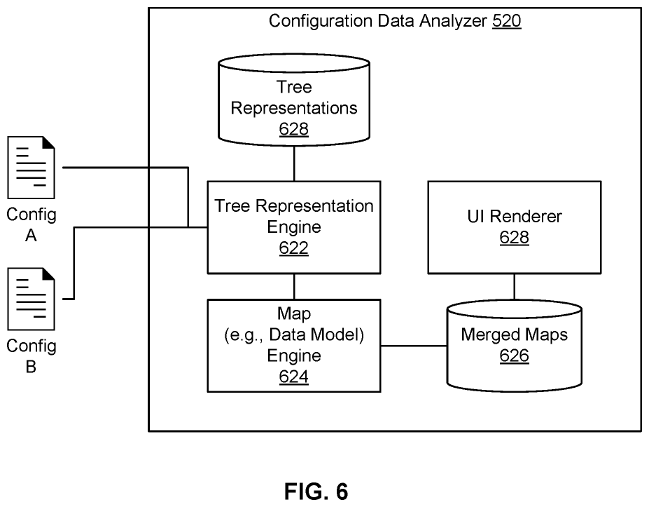

As used herein, “configuration data” refers to data/settings that define how a computer application operates. As further described with respect to FIGS. 6A and 6B, configuration data may be made up of sets of parameters, where a parameter may be a key-value pair, one or more alphanumeric values, a file, or some other type of content. For purposes of discussion herein, it may be assumed that parameters take the form of key-value pairs but other parameter forms may be employed. An example of a key-value pair is “ip-address: 10.0.177.15,” where the key is the text “ip-address” and the value is the IP address “10.0.177.15.” Key-value pairs can be stored in various types of structured or unstructured text files, database tables, and so on.

A configuration data analyzer provides insights and metrics about configuration data. The analysis may be powerful tools for performing root cause analysis and reporting to achieve a desired state. Suppose a developer is making a change to a computer application (sometimes simply referred to as an “application”), e.g., adding a feature or functionality. In the development process, it may be helpful for the developer to proactively see or simulate the changes in a different deployment of the application. For example, pushing out the feature in a first environment/locale causes degradations in application performance such as increased incidents, outages, or slower performance. The developer may find it helpful to see the effects of pushing out the feature prior to actual deployment. Returning to the example, suppose that pushing out the feature in a second environment/locale does not cause degradations in performance. It may be helpful to see the differences in configuration settings between the application in the first environment and the application in the second environment for proactive root cause analysis, among other things.

Existing tools such as version control, file compare, or diff compare may be able to track changes within the same application. Similarly, tools that compare differences between plaintext files exist. However, such tools are not able to track changes across different applications or Infrastructure as Code services.

Techniques for providing a configuration data analyzer are disclosed. The configuration data analyzer is capable of determining and tracking differences or changes between at least two applications. Unlike conventional version control systems that track changes within the same application such as between a current version of an application and an earlier or later version of the same application, the disclosed techniques may be applied to identify differences between two different applications.

The disclosed techniques identify differences between applications, where the applications may be different applications, different deployments of an application, or applications for different environments. Two applications may be considered different from each other if they are beyond merely different versions of the same application. For example, two applications may start from the same foundation but diverge over time when different changes are made. For example, the applications may have one or more different features or functionalities despite starting from the same foundation. Once the number of differences exceeds a threshold, then the two applications may be considered to be two different applications rather than different versions of the same application.

The disclosed techniques may be applied to a variety of settings such as for performing proactive root cause analysis. For example, a setting intended to be a temporary change is inadvertently left in a new state. The disclosed technique would be able to identify this change, allowing it to be reverted to a prior state. As another example, the disclosed techniques may be used for reporting. Suppose a user wishes to see the differences in five different environments, and there is a goal that the differences between the environments should not exceed 50 differences because, for this particular example, it is undesirable to have a great number of differences across different applications or there might be a desired end state of an application. By comparing states, a user may gradually migrate one application to a desired state by making changes over several iterations. After completion of each iteration, a user may want to use a configuration data analyzer to see the remaining changes that are required to reach the desired end state of the application.

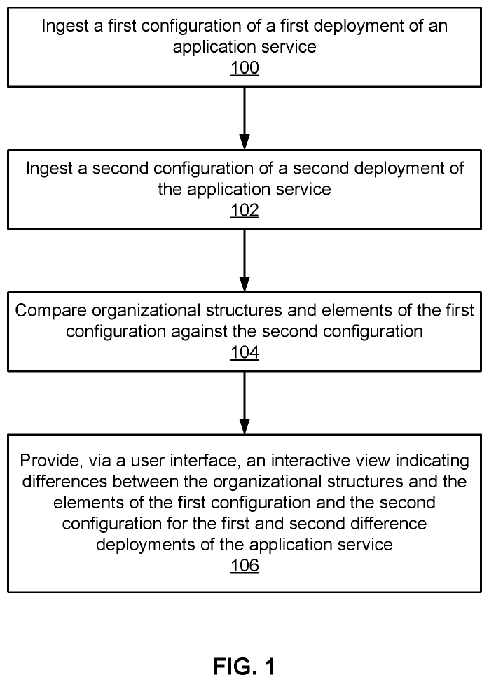

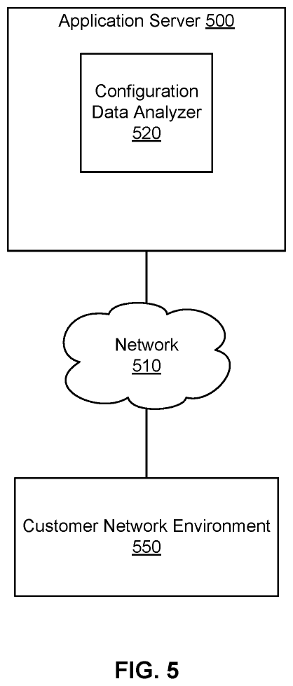

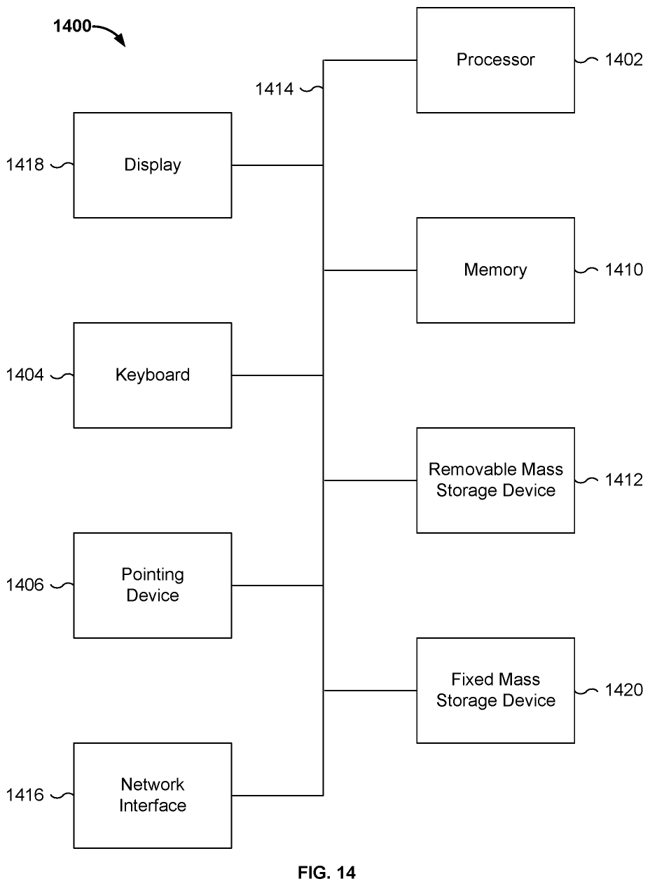

FIG. 1 is a flow diagram illustrating an embodiment of a process for providing a configuration data analyzer. This process may be implemented on or by the configuration data analyzer 520 of FIG. 5 or 6 or processor 1402 of FIG. 14.

As further described herein, analyzing the configuration data has many applications such as root cause analysis or reporting. In various embodiments, the process generates an alert that indicates a degradation in performance of the application service associated with at least one of the differences.

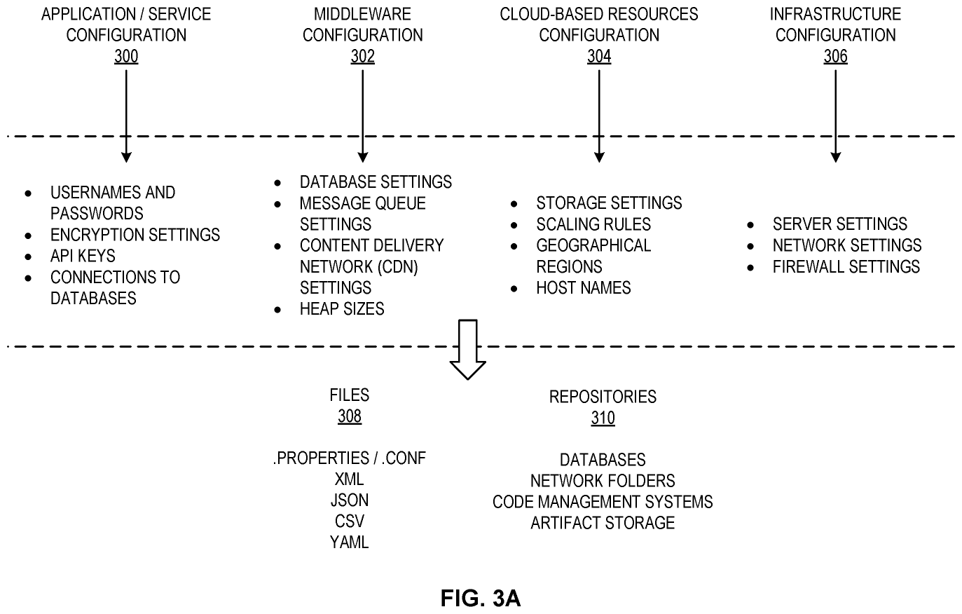

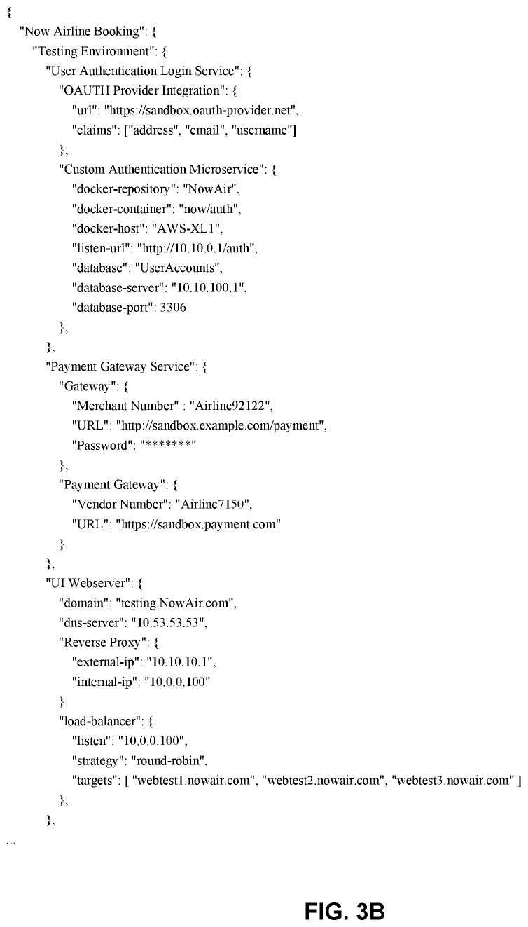

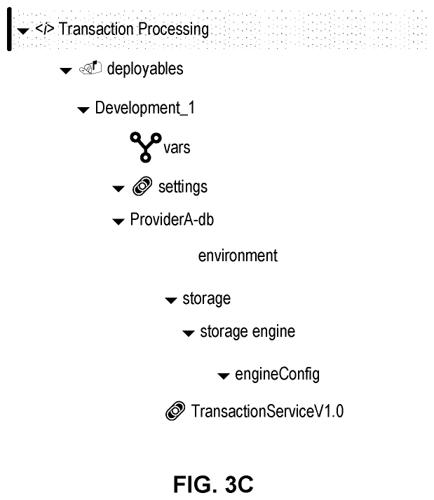

In the example shown, the process begins by ingesting a first configuration of a first deployment of an application service (100). The first configuration of the first deployment of the application service may include configuration data associated with the application service. An example of configuration data is further described with respect to FIGS. 3A-3C.

The process ingests a second configuration of a second deployment of the application service (102). Similar to the first configuration, the second configuration may include configuration data. However, the second configuration data is associated with a different deployment of the application service. A particular application service may have several different deployments. For example, an application may be deployed in one or more development environments, one or more production environments, and one or more test environments. Changes may be made to various deployments. Unlike different versions of an application, different deployments of the application may have significant differences that prevent conventional tools from being able to compare the deployments. For example, the structure of the deployments may be different, and conventional tools are unable to make comparisons when the structures are different. Sometimes, each deployment is referred to as a particular application, so that different deployments of a particular application may be considered to be different applications.

There may be various reasons for having different deployments of an application. For example, a technology company has various user-facing applications (users may be end users such as consumers) that enable the user to purchase devices/products, schedule consultations, and obtain device support. A particular application may be deployed in different environments and thus there are different versions of the application. For example, the technology company has operations in different countries so the applications may be localized to particular geographic locales. The localization may include specific languages, currency, and/or conforming to regulations such as security/privacy rules which may differ from place to place. Thus, a large enterprise may have on the order of thousands of applications.

Unlike existing solutions that show what has changed from a first version to a second version of a same application and deployment, the disclosed techniques allow changes to be shown between different deployments. There are new and unique challenges to displaying differences across deployments (as compared with changes within the same deployment). In one aspect, within the same deployment the structure remains substantially the same because the foundation of different versions of the same deployment is the same. By contrast, different deployments may have different structures. Existing techniques are typically unable to make comparisons when the structure of a first deployment is substantially different from the structure of a second deployment.

The process compares organizational structures and elements of the first configuration against the second configuration (104). In various embodiments, configuration data is organized within a folder structure. For example, configuration data may be located within a particular provider, which may be an internal provider or a third-party service provider. Unlike conventional comparison tools that are typically limited to comparing data from two sources with the same structure, the disclosed process can analyze data and identify differences between data coming from various sources including data within different organizational structures. In other words, this process is able to identify data structure differences as well as element (value) differences unlike conventional techniques that are limited to identifying value differences.

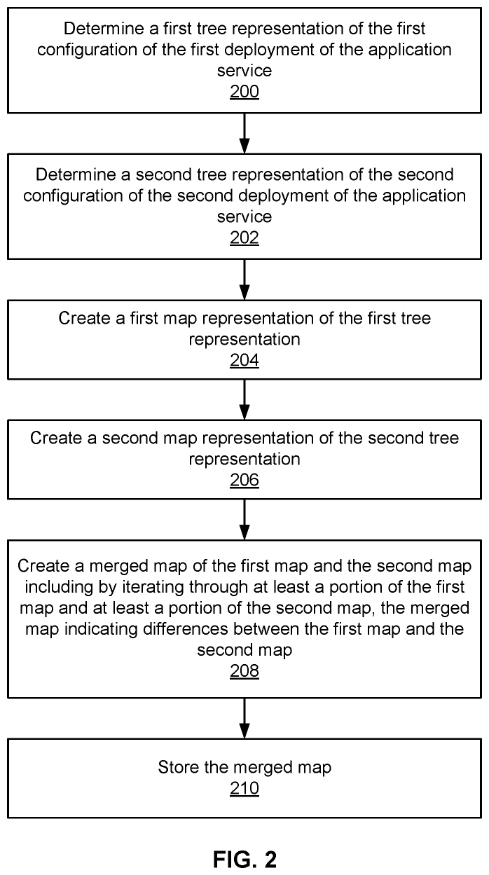

As further described with respect to FIG. 2, the comparison includes creating a data model for each of the first configuration and the second configuration, merging the data models, and determining various views representing the differences. Each view may be an interactive view that allows a user to interact with the view to further explore the differences. Differences between configurations may be stored at the tree level, so that those differences may be output along with the context (e.g., location within the tree). A benefit of having different views is that it aids in a user's understanding of the data and associated differences.

The process provides, via a user interface, an interactive view indicating differences between the organizational structures and the elements of the first configuration and the second configuration for the first and second different deployments of the application service (106). The first and second different deployments are of the same application service. The differences of the interactive view include at least one of: a variable difference, a configuration data item (CDI) difference, type difference, or source level difference. A differences view includes element/value differences while a data model view (sometimes called a tree view) shows differences in a hierarchical manner as further described herein. Storing separate values may improve the processing speed by allowing representations to be rendered more quickly in the interactive view because the calculation does not need to be repeated. The same underlying data may be presented in a list view, a tree view, code editor view, etc.

Differences may be identified by converting the configurations into a data model, as further described herein.

FIG. 2 is a flow diagram illustrating an embodiment of a process for building a data model based on a configuration file. This process may be performed as part of another process. For example, this process is an example of how to compare organizational structures and elements at 104 of FIG. 1. This process may be implemented on or by the configuration data analyzer 520 of FIG. 5 or 6 or processor 1402 of FIG. 14.

In the example shown, the process begins by determining a first tree representation of the first configuration of the first deployment of the application service (200). A tree representation of a configuration represents the data of the configuration as a tree. For example, a CDM query processes the data and outputs a JSON object. In various embodiments, each node in the tree has a type such as a folder node, a CDI node, a variable node, etc. The key may be a name path and the value may be a CDM node. By way of a non-limiting example, the tree representation is in a JSON object that can be stored. Storing the JSON object enables it to be queried for comparison or other purposes.

The process determines a second tree representation of the second configuration of the second deployment of the application service (202). The second tree representation may be created in the same manner as the first tree representation. The second configuration may be a different format (e.g., a different language such as XML or YAML) from the first configuration. By converting both configurations to a tree representation, they may be more easily compared because both configurations are now JSON objects, for example.

The process creates a first map representation of the first tree representation (204). In various embodiments, the first map representation includes a data model. The map representation may be created by performing a map function on a JSON object. In various embodiments, structural aspects may be captured in the map representation. For example, if the applications are different (e.g., if the applications are not the same entity), a name path may be transformed to assign a unique ID to each node. This is an alternative to using a name to create a path because if the name is later changed, the unique ID would still be able to identify that the path (structure) is unchanged despite the name change.

The process creates a second map representation of the second tree representation (206). The second map representation may be created in the same manner as the first map representation. The second map representation may have the same properties (e.g., it includes a data model) as the first map representation. Converting the underlying configuration data to a data model is beneficial because it makes the comparison of the data easier.

The process creates a merged map of the first map and the second map including by iterating through at least a portion of the first map and at least a portion of the second map, the merged map indicating differences between the first map and the second map (208). The merged map may indicate both changes and differences between the two maps. For example, node types may be different, nodes may be derived from parents differently, data may have been inherited differently (or not at all), data may be overwritten etc. By way of non-limiting example, Table 1 shows differences.

TABLE 1

| Category of | | |
|---|---|---|
| difference | Type of difference | Example node |
| CDI/variable | Secure to non- | URL |
| | secure | User |
| | Non-secure to | Pool |
| | secure | Password |
| | Value | |
| | Secret/encrypted | |
| | value | |
| Existence | Unique to | Bot_detection |
| | reference (only | Business rule |
| | exists in R) | AppConfig/webConfig/port |
| | Unique to target | |
| | (only exists in T) | |
| | Unique to | |
| | target/reference | |
| | and included | |
| Type (in various | CDI to folder | RAM |
| embodiments, | CDI to array | IP |
| this difference is | Array to CDI | Loglevel |
| noted but not | Array to folder | Clone |
| necessarily | Folder to CDI | Auxdb |
| exposed to the | Folder to array | |
| user) | | |
| Source level | Include to direct | Collections/release2.0/DBConfig2.0/aux_db |
| | Direct to include | Collections/release1.0/DBConfig1.0/db_version |
| | Include to | Collections/release1.0/DBConfig1.0/cache |
| | override | |
| | Override to | |
| | include | |

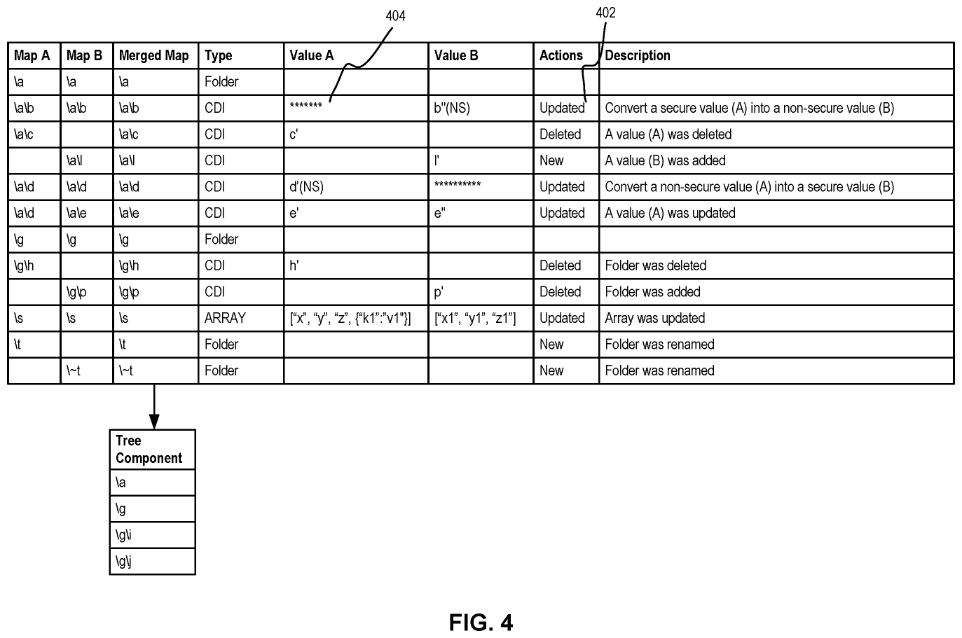

An example of a first map, a second map, and a merged map is further described herein with respect to FIG. 4.

In various embodiments, creating the merged map of the first map and the second map includes identifying folder differences between the first map and the second map. Conventional techniques are typically unable to identify folder differences, because conventional techniques are not able to identify structural differences.

In various embodiments, the first deployment of an application service operates in a first environment and the second deployment of the application service operates in a second environment different from the first environment as described herein. At least a portion of an organizational structure of the first deployment of an application service may be different from at least a portion of an organizational structure of the second deployment of the application service.

The process stores the merged map (210). The merged map may be processed to identify differences and those differences may be stored, e.g., as a JSON object. A benefit of storing the merged map (or a processed version of the merged map) is that the next time the same data model is used for a comparison, the computation does not need to be performed again. This improves the technical field of configuration data analysis, and improves the functioning of a computer by reducing the use of processing resources.

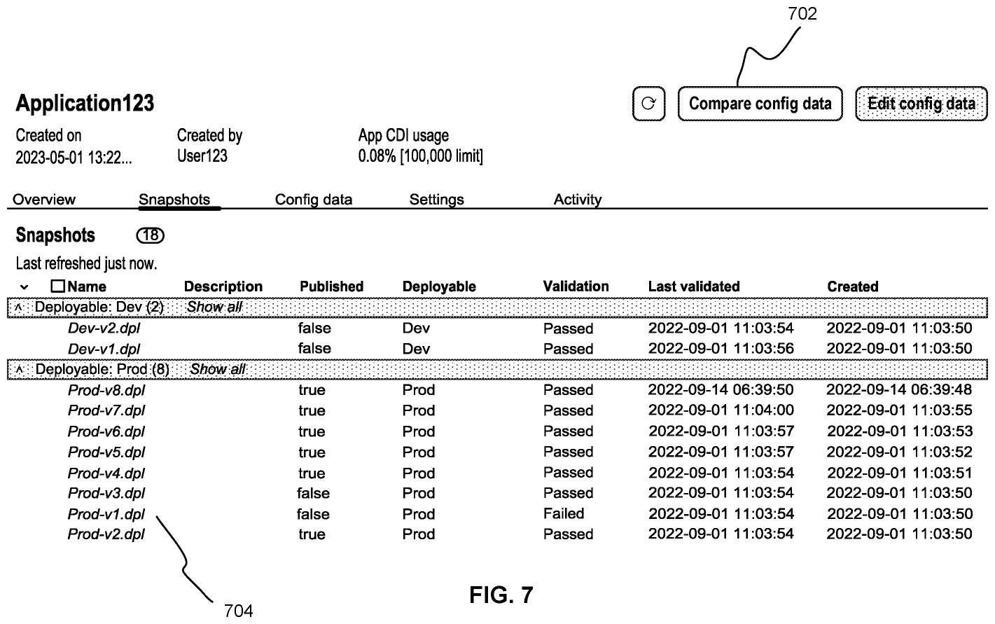

In various embodiments, a merged map generated by the process of FIG. 2 may be sorted. For example, the merged map may be sorted into alphabetical order or into a plurality of views. A benefit of presenting the configuration data analysis/differences in a variety of views is that it can be easier for a user to understand the analysis. Examples of views include context and dependency injection (CDI) List View, Data Model List View, Tree View, and Code Editor view and are shown in FIGS. 7-11.

FIG. 3A shows examples of configuration data, how the configuration data is stored, and where the configuration data can be stored. Application/service configuration 300 may include configuration data for specific software applications and/or services. These may be one or more of usernames and passwords, encryption settings, application programming interface (API) keys, or connections to databases. Middleware configuration 302 may include configuration data of features built into the remote network management platform that may be employed by the software applications and/or services. These may be one or more of database settings, message queue settings, content delivery network (CDN) settings, and/or heap sizes. Cloud-based resources configuration 304 may include configuration data relating to one or more public cloud network services used by the software applications and/or services. These may be one or more of storage settings, scaling rules (e.g., for processing, storage, and network capacity), geographical regions in which the cloud-based resources are located, and/or host names relating to these resources. Infrastructure configuration 306 may include configuration data directed to the operation of computing devices within the remote network management platform. These may be one or more of server device settings, network settings, firewall settings, and so on. For instance, these settings may include IP address assignments, domain name assignments, workgroup assignments, etc.

This configuration data may be stored in different ways spread across the remote network management platform, one or more public cloud networks, and/or other locations. For example, some of this configuration data may be stored in files 308, which may include unstructured text, structured text, or be other types of files—e.g., .properties, .conf, XML, JavaScript Object Notation (JSON), comma-separated-value (CSV), and/or Yet Another Markup Language (YAML) files. Alternatively or additionally, some of this configuration data (parameters and/or files) may be stored in repositories 310, which may include databases (e.g., specific database tables), network folders, source code management systems, and/or artifact storage.

FIG. 3B shows an example of configuration data. In this example, the configuration data is shown as a JSON file. In some cases, configuration data may be stored in a hierarchical tree-like structure. For instance, JSON and XML files are hierarchically structured in a fashion that is directly analogous to a tree. In these types of files, objects are either an element (e.g., a key-value pair that is like a leaf of a tree) or a container of other objects (e.g., a block of elements that is like a root or intermediate node in a tree).

As a concrete example, an airline booking web site can contain many nodes of application and service configuration data, such as a custom ticket reservation application, a user relations management component, a payment gateway service, a user interface, a series of webservers that provide content to the user interface, authentication microservices, database servers, load balancers, and internal network routing policies that all need to be configured properly in order to combine and operate seamlessly as the airline booking application service. As such, the configuration data of a software service may be extensive and number in the thousands of nodes storing tens of thousands of configuration key-value pairs in a tree-like hierarchy. A simplified example set of JSON configuration for such a software service is shown in the next figure.

FIG. 3C shows an example of configuration data arranged in a data model view. Key-value pairs may be stored in any of the folders in this example, making it difficult if not impossible to compare the configuration data.

The challenges of maintaining such configuration data are not only that the data is complex (tens of thousands to millions of parameters), but also that changes to it are frequent. For example, a remote network management platform may support hundreds or thousands of software applications and services, some fraction of which may be under continuous development processes, such as various types of agile programming models. As such, new versions of these applications may be deployed into a production environment every few days, or even several times in one day.

The teams of software engineers developing and testing these applications may make changes to the configuration data of their applications, but may also modify that of other applications, as well as that of middleware and/or infrastructure. Thus, to fix a software defect or to deploy a new feature, one team of software engineers may make changes to configuration data that affects the software applications of some or all other teams. Such changes may cause at least some of these other software applications to change behavior or to fail in various ways.

Further, each set of configuration data may be placed in files 308 and/or repositories 310 that are disposed throughout numerous locations. This leads to weak access restrictions for configuration data and the coordination of changes being difficult if not impossible. The result is that changes can be uncontrolled, can have no traceability, and cannot be easily audited.

As a consequence, a major root cause of software application and service outages is now errors in configuration data. In some estimates, these errors are even more prevalent and more impactful than coding errors in the software applications. Some notable configuration-related outages have taken entire web sites offline or rendered them impractical to use for hours or even days. Due to the aforementioned limitations, these outages are difficult to troubleshoot because narrowing down the configuration changes that may have caused the outage is akin to looking for a needle in a haystack across multiple files and repositories, which may contain thousands or millions of key-value pairs.

Therefore, any improvement in how configuration data is managed, presented, viewed, and manipulated such that outages are less likely to occur and faster to resolve would be beneficial.

FIG. 4 is a conceptual diagram illustrating an embodiment of analysis of two sets of configuration data. The first column (Map A) corresponds to a first map representation, the second column corresponds to a second map representation (Map B), and the third column corresponds to a merged map of Map A and Map B. Each row represents a particular level of the tree. Determining whether a folder exists in both maps may be performed as follows. Each node in the map is assigned a unique ID. The ID is used to create a path. Each map has a key, so if a key exists for both maps, then the folder exists. If there is a difference, the type of difference (e.g., update, insert, delete) may be determined. A technique such as diff-to-alert may be used to identify the type of difference.

Conventionally, only differences in values could be identified. By contrast, the disclosed techniques can identify other types of differences. For example, if a first configuration has a CDI and a second configuration has a node, the difference (which is a conversion of a node from a CDI to a folder) may be identified. Another type of difference is converting an array into a CDI.

At least some of the data may have security features such as being encrypted. In various embodiments, configuration data (e.g., a CDI) can include encrypted and/or non-encrypted data. A user may or may not have permission to view the encrypted data as determined by the privileges given to the user. If the user does not have permission to view the encrypted data, the encrypted data is obscured in the interactive view provided on the user interface. For example, the data is represented with asterisks. If a user does not have permission to view encrypted data, the difference may be indicated without revealing the actual values. In various embodiments, a process determines whether a user has permission to view encrypted data. If the user does not have permission to view the encrypted data, then a difference between the first configuration and the second configuration is indicated without displaying a value of the encrypted data. An example is shown at 402. If the user does not have permission to view the encrypted data, the encrypted data in the interactive view provided on the user interface is obscured. An example is 404, which does not show the actual value of encrypted data (Value A), and simply indicates that there has been an update.

FIG. 5 is a block diagram illustrating an embodiment of a network environment including a configuration data analyzer. In the example shown, application server 500 and customer network environment 550 are connected via network 510. Network 510 can be a public or private network. In some embodiments, network 510 is a public network such as the Internet. In various embodiments, application server 500 is a cloud-based application server that provides application services including an information technology operations management (ITOM) cloud service to determine metrics including resource expenditures of a digital service (sometimes simply referred to as “services”) running within a customer network such as customer network environment 550. Application server 500 together with a server internal to customer network environment 550 are part of a platform for gathering requirements for a computer program specification and creating stories using the requirements.

In some embodiments, application server 500 provides cloud-based services for managing information technology operations including creating computer programs in cooperation with the customer's information technology environment. In some embodiments, application server 500 offers additional cloud services such as a configuration management database (CMDB) service for managing devices and/or configuration items for a customer. In some embodiments, application server 500 provides functionality to analyze configuration data.

In some embodiments, customer network environment 550 is an information technology network environment and includes multiple hardware devices. Each of the devices or other components of the environment 550 may include configuration data.

Although single instances of some components have been shown to simplify the diagram of FIG. 5, additional instances of any of the components shown in FIG. 5 may exist. For example, application server 500 may include one or more servers and/or may share servers. In some embodiments, components not shown in FIG. 5 may also exist. For example, network clients used to access application server 500 are not shown.

FIG. 6 is a block diagram illustrating an embodiment of a configuration data analyzer. The system includes a tree representation engine 622, a map engine 624, a UI renderer 628, and one or more storage devices 626 and 628. The tree representation engine 622 is configured to determine a tree representation of a configuration file (here, Config A and Config B). The map engine 624 is configured to determine a data model/map representation of a tree representation. The UI renderer 628 is configured to provide an interactive view of differences identified between the configuration files. The system may include one or more databases to store the tree representations (628) or merged maps (626). As described herein, a benefit of storing the tree and/or merged maps is reduced processing time since the information may be used instead of recalculated each time a data model object corresponding to a particular configuration is to be used to analyze the configuration.

The following figures show some examples of user interfaces. These user interfaces are examples of the interactive view of differences between the organizational structures and the elements of the first configuration and the second configuration for the first and second different deployments of the same application service provided at 106 of FIG. 1.

FIG. 7 shows an example of a graphical user interface for providing an overview of configuration data. The graphical user interface (GUI) includes a portion (here, at the top) that indicates the application (computer program), when it was created, who it was created by, and the CDI usage. The GUI includes a menu to display an overview of the application, snapshots (also referred to as configuration artifacts) associated with the application, configuration data, settings, and activity. In this example, snapshots are displayed, with each row displaying a separate snapshot. The status of the snapshots is displayed “last refreshed just now,” to indicate when the view was most recently updated.

Buttons on the GUI can be selected to trigger various processes, such as refreshing the view to fetch any updates to the snapshots, comparing configuration data, and editing configuration data.

In various embodiments, selecting button 702 causes at least a portion of a configuration data analysis process (e.g., the process of FIG. 1) to be performed. The user interface may display progress of a comparison process. For example, the user interface displays the percentage of (or stages of) the process that has been completed.

Snapshots may be grouped to expand or collapse groups of the snapshots. In this example, both groups (Deployable: Dev (2) and Deployable Prod (8)) are expanded to review the constituent snapshots. Each of the rows may be selected to view the snapshot. The next figure shows an example of a GUI that is displayed in response to selecting snapshot 704.

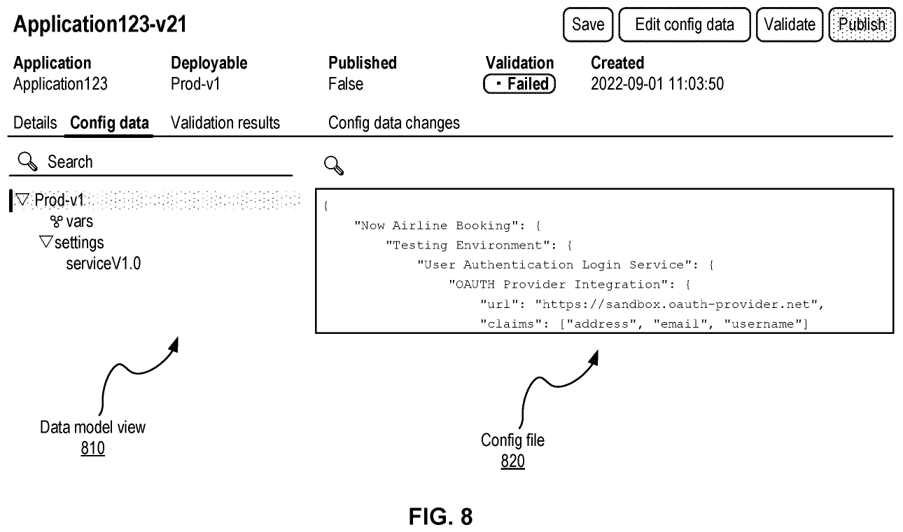

FIG. 8 shows an example of a graphical user interface for a snapshot. This example GUI may be displayed in response to selecting a snapshot such as 704 of FIG. 7. The GUI includes menu items at the top, a data model view 810, and a configuration file 820. The contents of the configuration file 820 are displayed. Here, the configuration file is a JSON file. Another example of a configuration file is shown in FIG. 3B. A data model view 810 shows a data model corresponding to the configuration file. The data model may be generated using the techniques disclosed herein, e.g., the process of FIG. 2. Another example of a data model view is FIG. 3C.

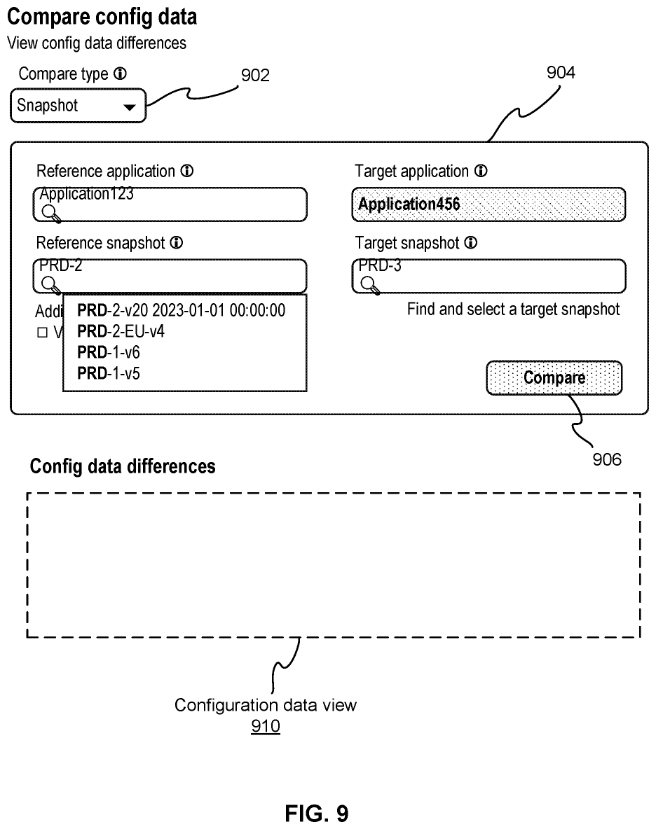

FIG. 9 shows an example of a graphical user interface for comparing configuration data. The GUI may be displayed in response to selecting button 702 of FIG. 7. A user may interact with this GUI to compare snapshots. In this example, the comparison type is a snapshot, meaning two snapshots are compared. As further described herein, rather than snapshots, other types of data such as data models or applications may be compared. A user may select the type of comparison via component 902 (here, a drop-down menu). A user may input information about the comparisons to be made in area 904. In this example, a user may search for and/or select a reference application (sometimes referred to as “R”) and a target application (sometimes referred to as “T”). Snapshots associated with the reference and target applications may be loaded, and a user may select specific snapshots to compare. In this example, the search includes an auto-complete feature to facilitate user input of valid snapshot names.

Selecting button 906 causes at least a portion of a configuration data analysis process (e.g., the process of FIG. 1) to be performed. For example, the entire process of FIG. 1 is performed to display analysis (including differences) between reference snapshot PRD-2 and target snapshot PRD-3. As another example, the reference and target snapshots have been previously compared, so only 106 of FIG. 1 is performed. The merge map was previously stored as a result of the previous comparison, and selecting the button causes the merge map to be retrieved and the interactive view to be displayed here. This may improve efficiency and user experience compared with other techniques by decreasing the processing latency and serving results faster.

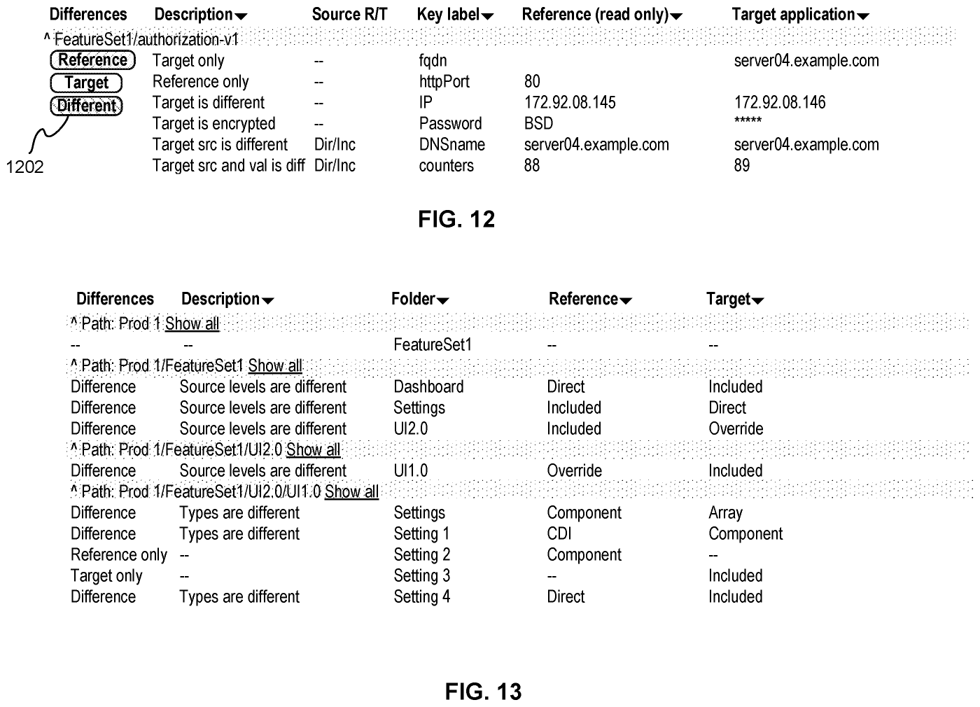

Configuration data differences may be displayed in configuration data view area 910. Various views may be displayed, and an example is further described with respect to FIGS. 12 and 13.

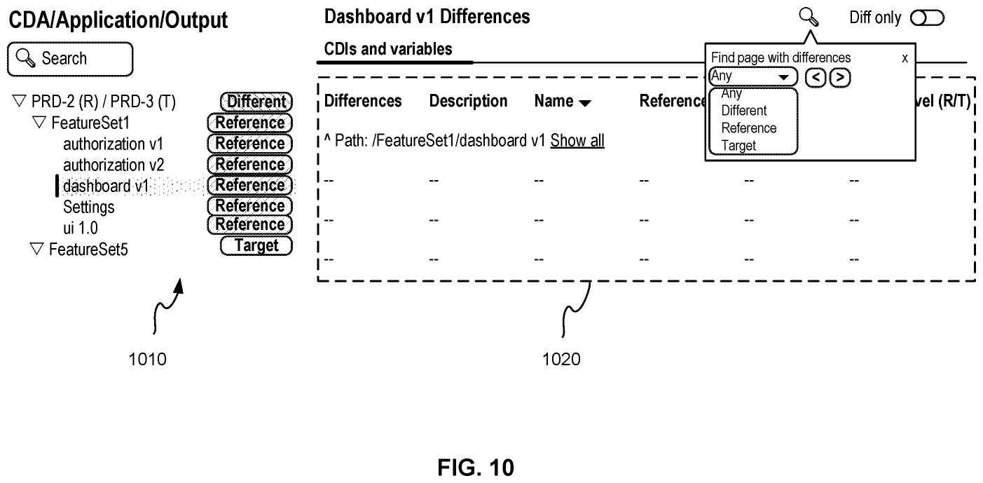

FIG. 10 shows an example of a graphical user interface for comparing data models. The GUI may be displayed in response to selecting CDI and variables (instead of snapshot) at 902 and selecting button 906 of FIG. 9. Returning to FIG. 10, a user may interact with this GUI to compare CDIs and variables of a first configuration file with CDIs and variables of a second configuration file. The GUI includes menu items at the top, a data model view 1010, and a differences view 1020. The data model view 1010 and the differences view 1020 are representations of the same information. The interactive view shown here organizes the differences by corresponding nodes (view 1010) and/or corresponding paths (view 1020). The data model view (sometimes called a tree view) shows a structure or hierarchy of the path, while the differences view shows details associated with specific paths.

The data model view 1010 indicates differences between a first tree representation of the first configuration of the first deployment of the application service (PRD-2) and a second tree representation of the second deployment of the application service (PRD-3). As further described with respect to FIG. 12, the type of difference may be indicated by a label or tag (here, “Different,” “Reference,” and “Target”). In other words, the label indicates a difference including by visually indicating an element in an organizational structure and whether the element is present in at least one of: the first deployment of an application service or the second deployment of an application service.

The differences view 1020 shows details associated with items selected in the data model view. In this example, selecting dashboard v1 in the data model view 1010 causes associated details to be displayed in differences view 1020. Here, the path corresponding to dashboard v1 is shown. In this example, there are no differences between the CDI and variables of PRD-2 (the reference) and PRD-3 (the target). One of the menu items shown is a search feature, which causes a pop-up to facilitate search of differences (e.g., any/all, different, reference, target) on the GUI. Other examples of a differences view are shown in FIGS. 12 and 13.

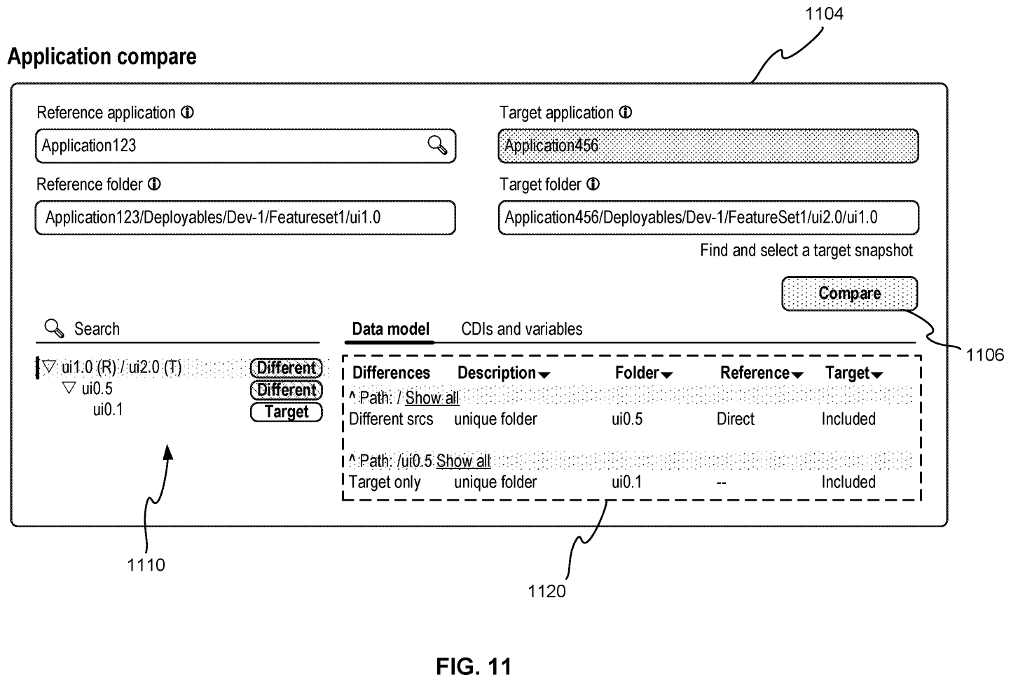

FIG. 11 shows an example of a graphical user interface for comparing applications. Each of the components are like their counterparts in FIG. 9 unless otherwise described. For simplicity, only a portion of the GUI corresponding to FIG. 9 is shown. For example, area 1104 corresponds to area 904 of FIG. 9. A user may interact with this GUI to compare a first application with a second application. In this example, the first application is reference application Application123 and the second application is target application Application456. In this example, the folders associated with the applications are displayed.

In response to selecting compare button 1106, a data model view 1110 and a differences view 1120 are displayed. In this example, all paths are shown expanded in area 1120. This interactive view includes at least one difference in configuration data. Here, one difference is at the root node (Path:/) where the sources are different. Specifically, ui0.5 is direct for the reference but included in the target. Direct means that the folder was created directly at that path. Included means that the folder was inherited. This is an example of how folder level differences are shown. In other words, structural level differences including properties about the organizational structure (e.g., folder properties) are determined. The properties may be simply stored for calculations and/or may be presented to a user. Another difference is at the node corresponding to ui0.5 (Path:/ui0.5). Specifically, folder ui0.1 is present in the target but not the reference.

In this view, the differences between data models are displayed. That is, the interactive view includes at least one difference between a first data model representing the first configuration and a second data model representing the second configuration. The data models corresponding to the configurations may be obtained using the disclosed techniques, e.g., the process of FIG. 2. A user may view the differences between the applications in terms of CDIs and variables (instead of data models) by selecting the menu item.

FIG. 12 shows an example of a graphical user interface for displaying differences in configuration data. The differences shown here may be displayed as part of another GUI such as within area 910 of FIG. 9, area 1020 of FIG. 10, or area 1120 of FIG. 11. In this example, a label 1202 visually distinguishes between different types of differences. Here, “Reference” means a particular set of data is present in a reference snapshot/file/application but not in a target snapshot/file/application. Similarly, “Target” means a particular set of data is present in a target snapshot/file/application but not in a reference snapshot/file/application. “Different” means a particular set of data is different between a reference snapshot/file/application and a target snapshot/file/application. For example, the keys exist in both, but the values are different. Details about the differences may be displayed, providing more detailed information about the nature of the differences.

FIG. 13 shows another example of a graphical user interface for displaying differences in configuration data. The differences shown here may be displayed as part of another GUI such as within area 910 of FIG. 9, area 1020 of FIG. 10, or area 1120 of FIG. 11. In this example, all of the paths are shown expanded. Compared with FIG. 12, different details are displayed. For example, the folder in which the data resides is shown. The information displayed in FIGS. 7-13 may be obtained from the data model as described herein.

FIG. 14 is a functional diagram illustrating a programmed computer system for providing a configuration data analyzer in accordance with some embodiments. As will be apparent, other computer system architectures and configurations can be used to provide a configuration data analyzer. Computer system 1400, which includes various subsystems as described below, includes at least one microprocessor subsystem (also referred to as a processor or a central processing unit (CPU)) 1402. For example, processor 1402 can be implemented by a single-chip processor or by multiple processors. In some embodiments, processor 1402 is a general purpose digital processor that controls the operation of the computer system 1400. Using instructions retrieved from memory 1410, the processor 1402 controls the reception and manipulation of input data, and the output and display of data on output devices (e.g., display 1418). In some embodiments, processor 1402 includes and/or is used to provide a configuration data analyzer and/or executes/performs the processes described with respect to FIGS. 1 and 2.

Processor 1402 is coupled bi-directionally with memory 1410, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 1402. Also as is well known in the art, primary storage typically includes basic operating instructions, program code, data and objects used by the processor 1402 to perform its functions (e.g., programmed instructions). For example, memory 1410 can include any suitable computer-readable storage media, described below, depending on whether, for example, data access needs to be bi-directional or uni-directional. For example, processor 1402 can also directly and very rapidly retrieve and store frequently needed data in a cache memory (not shown).

A removable mass storage device 1412 provides additional data storage capacity for the computer system 1400, and is coupled either bi-directionally (read/write) or uni-directionally (read only) to processor 1402. For example, storage 1412 can also include computer-readable media such as magnetic tape, flash memory, PC-CARDS, portable mass storage devices, holographic storage devices, and other storage devices. A fixed mass storage 1420 can also, for example, provide additional data storage capacity. The most common example of mass storage 1420 is a hard disk drive. Mass storage 1412, 1420 generally store additional programming instructions, data, and the like that typically are not in active use by the processor 1402. It will be appreciated that the information retained within mass storage 1412 and 1420 can be incorporated, if needed, in standard fashion as part of memory 1410 (e.g., RAM) as virtual memory.

In addition to providing processor 1402 access to storage subsystems, bus 1414 can also be used to provide access to other subsystems and devices. As shown, these can include a display monitor 1418, a network interface 1416, a keyboard 1404, and a pointing device 1406, as well as an auxiliary input/output device interface, a sound card, speakers, and other subsystems as needed. For example, the pointing device 1406 can be a mouse, stylus, track ball, or tablet, and is useful for interacting with a graphical user interface.

The network interface 1416 allows processor 1402 to be coupled to another computer, computer network, or telecommunications network using a network connection as shown. For example, through the network interface 1416, the processor 1402 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 1402 can be used to connect the computer system 1400 to an external network and transfer data according to standard protocols. For example, various process embodiments disclosed herein can be executed on processor 1402, or can be performed across a network such as the Internet, intranet networks, or local area networks, in conjunction with a remote processor that shares a portion of the processing. Additional mass storage devices (not shown) can also be connected to processor 1402 through network interface 1416.

An auxiliary I/O device interface (not shown) can be used in conjunction with computer system 1400. The auxiliary I/O device interface can include general and customized interfaces that allow the processor 1402 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 14 is but an example of a computer system suitable for use with the various embodiments disclosed herein. Other computer systems suitable for such use can include additional or fewer subsystems. In addition, bus 1414 is illustrative of any interconnection scheme serving to link the subsystems. Other computer architectures having different configurations of subsystems can also be utilized.

The analysis (e.g., comparison) made by the disclosed configuration data analyzer is not capable of being performed mentally (e.g., in the mind) because of the structure and/or volume of data. For example, for a banking application, there may be on the order of 10 million key-value pairs. In one aspect, applications are typically very complicated and includes many features and functions. In another aspect, configuration data may be stored in a tree structure having one or more nested subfolders within folders. Consequently, the comparison is not a simple comparison of one set of key-value pairs to another set of key-value pairs because key-value pairs are stored in various folders/locations. For example, a particular key-value pair may be present in an engine configuration, environment, settings, or somewhere else.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method comprising:
ingesting a first configuration of a first deployment of an application service;
ingesting a second configuration of a second deployment of the application service;
comparing organizational structures and elements of the first configuration against the second configuration; and
providing, via a user interface, an interactive view indicating differences between the organizational structures and the elements of the first configuration and the second configuration for the first and second different deployments of the application service.

2. The method of claim 1, wherein comparing the organizational structures and the elements of the first configuration and the second configuration includes:
determining a first tree representation of the first configuration of the first deployment of the application service;
determining a second tree representation of the second configuration of the second deployment of the application service;
creating a first map representation of the first tree representation;
creating a second map representation of the second tree representation;
creating a merged map of the first map representation and the second map representation including by iterating through at least a portion of the first map representation and at least a portion of the second map representation, the merged map indicating differences between the first map representation and the second map representation; and
storing the merged map.

3. The method of claim 2, wherein creating the merged map of the first map representation and the second map representation includes identifying folder differences between the first map representation and the second map representation.

4. The method of claim 2, further comprising sorting the merged map into a plurality of views.

5. The method of claim 4, wherein the plurality of views includes at least one of a context and dependency injection (CDI) list view, a data model list view, a tree view, or a code editor view.

6. The method of claim 2, wherein:
the first map representation includes a first data model of the first tree representation; and
the second map representation includes a second data model of the second tree representation.

7. The method of claim 1, wherein the first deployment of the application service operates in a first environment and the second deployment of the application service operates in a second environment different from the first environment.

8. The method of claim 1, wherein at least a portion of an organizational structure of the first deployment of the application service is different from at least a portion of an organizational structure of the second deployment of the application service.

9. The method of claim 1, wherein the differences of the interactive view includes at least one of: a variable difference, a context and dependency injection (CDI) difference, type difference, or source level difference.

10. The method of claim 1, further comprising:
determining whether a user has permission to view encrypted data; and
in response to a determination that the user does not have permission to view the encrypted data, indicating that there is a difference between the first configuration and the second configuration without displaying a value of the encrypted data.

11. The method of claim 10, further comprising, in response to the determination that the user does not have permission to view the encrypted data, obscuring the encrypted data in the interactive view provided on the user interface.

12. The method of claim 1, further comprising generating an alert that indicates a degradation in performance of the application service associated with at least one of the differences.

13. The method of claim 1, wherein the interactive view includes at least one difference in configuration data.

14. The method of claim 1, wherein the interactive view includes at least one difference between a first data model representing the first configuration and a second data model representing the second configuration.

15. The method of claim 1, wherein the interactive view organizes the differences by at least one of: corresponding nodes or corresponding paths.

16. The method of claim 1, wherein the interactive view includes a data model view and a differences view.

17. The method of claim 1, wherein the interactive view includes a data model view indicating differences between a first tree representation of the first configuration of the first deployment of the application service and a second tree representation of the second deployment of the application service.

18. The method of claim 1, wherein the interactive view of differences indicates a difference including by visually indicating an element in an organizational structure and whether the element is present in at least one of: the first deployment of the application service or the second deployment of the application service.

19. A system, comprising:
a processor configured to:
ingest a first configuration of a first deployment of an application service;
ingest a second configuration of a second deployment of the application service;
compare organizational structures and elements of the first configuration against the second configuration; and
provide, via a user interface, an interactive view indicating differences between the organizational structures and the elements of the first configuration and the second configuration for the first and second different deployments of the application service; and
a memory coupled to the processor and configured to provide the processor with instructions.

20. A computer program product embodied in a non-transitory computer readable medium and comprising computer instructions for:
ingesting a first configuration of a first deployment of an application service;
ingesting a second configuration of a second deployment of the application service;
comparing organizational structures and elements of the first configuration against the second configuration; and
providing, via a user interface, an interactive view indicating differences between the organizational structures and the elements of the first configuration and the second configuration for the first and second different deployments of the application service.
